(19) United States
(12) Patent Application Publication
(10) Pub. No.: US 2023/0201636 A1
(43) Pub. Date: Jun. 29, 2023

(54) RESPIRATOR MASK

(71) Applicant: Eurofilters Holding N.V., Overpelt (BE)

(72) Inventors: Ralf Sauer, Overpelt (BE); Jan Schultink, Overpelt (BE)

(73) Assignee: Eurofilters Holding N.V., Overpelt (BE)

(21) Appl. No.: 17/927,121

(22) PCT Filed: May 10, 2021
(86) PCT No.: PCT/EP2021/062314

§ 371 Date: Nov. 22, 2022

(30) Foreign Application Priority Data
May 28, 2020 (EP) 20177105.2

(51) Int. Cl. A62B 23/02

(52) U.S. Cl. CPC A62B 23/025

(57) ABSTRACT

The invention provides a respirator mask comprising a filter material piece made from an air-permeable material and at least one securing band, wherein the air-permeable material comprises at least one layer of a non-woven biodegradable material, wherein the at least one securing band is designed for securing the respirator mask to the head.

The invention relates to a respirator mask.

Respirator masks consistently cover the wearer's mouth and nose with a filter material and are used to protect them from airborne pollutants and to protect the environment from exhaled bacteria and viruses. In this regard, the term includes, among others, in particular a surgical mask, medical face masks and filtering half masks.

The filter material used nowadays generally consists of a non-woven fabric made of plastic material. Many respirator masks are intended for single use and are disposed of afterwards.

Given the ever-increasing demand for respirator masks, this results in a large amount of waste consisting of plastic material.

In view of this, the object underlying the invention is to provide an ecologically improved respirator mask with good filtering and protection properties.

This object is achieved by a respirator mask according to claim 1.

The invention provides a respirator mask comprising a filter material piece made of an air-permeable material and at least one securing band,

wherein the air-permeable material comprises at least one layer of a biodegradable non-woven fabric,

wherein the at least one securing band is designed to secure the respirator mask to the head.

The fact that the air-permeable material comprises at least one biodegradable non-woven layer, i.e. at least one layer made of a biodegradable non-woven fabric, enables a disposal of the respirator mask in a more environmentally friendly manner.

For the purposes of the present invention, a “non-woven fabric” means an entangled mesh which has undergone a bonding step (non-woven bonding step) so that it has sufficient strength to be wound into rolls or unwound from these, in particular by machine (i.e. on an industrial scale). The minimum web tension required for such a winding into rolls is 0.044 N/mm. The web tension should not be higher than 10% to 25% of the minimum maximum tensile force (according to DIN EN 29073-3:1992-08) of the material to be wound. This results in a minimum maximum tensile force for a material to be wound of 8.8 N per 5 cm strip width.

A “fibre web” (or just “web”) corresponds to an entangled mesh, which, however, has not undergone a bonding step, so that, in contrast to a non-woven fabric, such an entangled mesh does not have sufficient strength to be wound into rolls or unwound from these by machine, for example.

The term “non-woven fabric” is used in other words as defined in ISO standard ISO 9092:1988 or CEN standard EN 29092. Details on the use of the definitions and/or processes described therein may also be found in the textbook “Vliesstoffe”, H. Fuchs, W. Albrecht, WILEY-VCH, 2012.

“Fibres” refers to both fibres of finite length (e.g. staple fibres) and fibres of theoretically infinite length, i.e. continuous fibres or filaments.

The air-permeable material may in particular comprise a non-woven fabric layer, i.e. a layer of non-woven fabric, which is made of a biodegradable material, in particular a biodegradable plastic material.

Biodegradable plastic materials may be removed from the environment through biological degradation and returned to the mineral material cycle. In particular, “biodegradable plastic materials” refers to plastic materials that fulfil the criteria of the European standards EN 13432 and/or EN 14995.

The biodegradable plastic material may in particular comprise a polylactide (PLA), a polyhydroxyalkanoate (PHA), a polycaprolactone (PCL), a cellulose ester, in particular cellulose acetate, polybutylene adipate terephthalate (PBAT) or polybutylene succinate (PBS).

The processing of biodegradable plastic materials into non-woven fabrics is described, for example, in U.S. Pat. No. 6,207,601 or EP 0 885 321.

The biodegradable non-woven fabric may be a dry-laid or wet-laid non-woven fabric or an extruded non-woven fabric, in particular a meltblown, spunbonded or spun-blown non-woven fabric.

The biodegradable non-woven fabric may comprise staple fibres or continuous fibres. In terms of production engineering, several layers of staple fibres or continuous fibres may also be provided, which are bonded to form exactly one layer of non-woven fabric.

The air-permeable material may in particular comprise exactly one filtrating layer, wherein the exactly one filtrating layer corresponds to the biodegradable non-woven layer. A filtrating layer is defined here as a layer that is relevant for filtering the air flow to be filtered. The air-permeable material may further comprise a mesh. The mesh may be used for the aesthetic design, for example the colour design, of the respirator mask. The mesh may also be used to improve the stability of the filter material piece of the respirator mask. The mesh may be, for example, an extruded mesh or a woven mesh. The mesh may have a mesh size of at least 1 mm, in particular at least 3 mm. The mesh may be made of a biodegradable material.

The filter material piece or the air-permeable material may consist of a biodegradable non-woven fabric layer. The filter material piece may be thus a single layer material, the single layer corresponding to the biodegradable non-woven fabric layer. In this case, the biodegradable non-woven fabric layer may in particular be designed as a biodegradable meltblown layer or spun-blown layer. In particular, in this case, no support layer or reinforcement layer is provided for the biodegradable non-woven fabric layer. In other words, the biodegradable non-woven fabric layer may be designed to withstand the usual stress of manufacture and use. In this case, the entire filter material piece is manufactured in a simple biodegradable way.

The biodegradable non-woven fabric may be a calendered non-woven fabric, in particular a non-woven fabric calendered thermally or by means of ultrasound. For thermal calendering, the initially unbonded non-woven may be passed between two rollers, at least one of which is heated to the melting temperature of the fibres forming the non-woven. At least one of the calendering rollers may have projections. As a result, fusion zone areas or spot welds may be formed.

Ultrasonic calendering or ultrasonic bonding is based on the conversion of electrical energy into mechanical vibration energy. In this process, bonding horns are caused to vibrate, whereby the fibres at their crossing points in the non-woven material are softened and welded together at the vibration points. This may lead to the formation of spot welds.

The air-permeable material may be multi-layered, wherein at least one, more or all of the layers comprise or are formed from a biodegradable non-woven fabric.

The air-permeable material may also comprise one or more additional layers which do not comprise a non-woven fabric, for example a mesh. In this case, the additional layers may also be made of or comprise a biodegradable material.

The biodegradable non-woven fabric layer may have a weight per unit area of 20 g/m² to 200 g/m², in particular 40 g/m² to 150 g/m², in particular 80 g/m².

The biodegradable non-woven fabric layer may have a maximum tensile force in the machine direction of more than 20 N, in particular more than 40 N, and/or in the transverse direction of more than 20 N, in particular more than 40 N.

The biodegradable non-woven fabric layer may have an air permeability of 100 l/(m²s) to 1000 l/(m²s), in particular 300 l/(m²s) to 600 l/(m²s), in particular 400 l/(m²s) to 500 l/(m²s).

The biodegradable non-woven fabric layer may be electrostatically charged. In a multi-layer construction, one, several or all of the non-woven fabric layers may be electrostatically charged. In particular, a meltblown layer may be electrostatically charged.

The fibres may be electrostatically charged before bonding and/or the nonwoven fabric, i.e. after bonding. PLA in particular has proven to be advantageous for electrostatic charging.

The biodegradable non-woven fabric layer may be electrostatically charged by a corona process. Alternatively or additionally, the biodegradable non-woven layer may be electrostatically charged by a process according to the teachings of U.S. Pat. No. 5,401,446. Another alternative consists in using additives and a water jet treatment (hydro charging) described for example in WO 97/07272.

The filter part or the filter material piece of the (finished but unused) respirator mask may have (in top view) a polygonal, in particular substantially rectangular shape. This also applies in particular to the case of a filter material piece with folds. The filter part or the filter material piece may have a three-dimensional shape, for example caused by spatial reshaping. The latter in particular allows a more precise fit to the face shape, resulting in a lower leakage volume flow.

According to one embodiment, the air-permeable material may comprise at least one support layer and at least one fine filter layer, wherein the at least one support layer and/or the at least one fine filter layer are a biodegradable non-woven fabric layer.

One or both carrier layers may be a non-woven fabric, in particular spunbonded or spun-blown. Alternatively, one or both carrier layers may be a mesh (netting). The mesh may have characteristics as described in EP 2 011 556 A1, which is hereby incorporated by reference.

A support layer (sometimes also called “carrier layer” or “reinforcing layer”) within the meaning of the present invention is a layer which provides the necessary mechanical strength to the multi-layer composite of the filter material piece. This refers to an open, porous non-woven fabric or a non-woven fabric with a light weight per unit area. One of the purposes of a support layer is to support other layers. The support layer, as well as any other layer of the filter material, may also be electrostatically charged, provided that the material has suitable dielectric properties.

A fine filter layer serves to increase the filtration performance of the multi-layer filter material piece by trapping particles that pass through the support layer, for example. To further increase the separation efficiency, the fine filter layer may preferably be electrostatically charged (e.g. by corona discharge or hydro charging).

Each support layer of the respirator masks may be a spunbonded or spun-blown non-woven, preferably with a grammage between 5 and 80 g/m², more preferably between 10 and 50 g/m², more preferably between 15 and 30 g/m² and/or preferably with a titre of the fibres forming the spunbonded non-woven in the range of 0.5 to 15 dtex.

The air-permeable material may preferably comprise one to three support layers.

When two support layers exist, the total grammage of the sum of all support layers is preferably 10 to 200 g/m², more preferably 15 to 150 g/m², more preferably 20 to 100 g/m², more preferably 30 to 90 g/m², in particular 40 to 70 g/m².

In particular, it is preferred that all support layers are made of a biodegradable non-woven fabric. A support layer in the form of a spunbonded or a spun-blown non-woven may be made of PBAT (e.g. Ecoflex from BASF) or another biodegradable polyester such as Duvaltex.

According to a further advantageous embodiment, each fine filter layer is an extruded non-woven fabric, in particular a meltblown non-woven fabric. The extruded non-woven fabric preferably has a grammage of 10 to 80 g/m², more preferably 15 to 50 g/m², in particular 20 to 40 g/m². A meltblown non-woven fabric may in particular be made of PLA.

The air-permeable material may comprise 1 to 5 fine filter layers.

When at least two fine filter layers exist, the total grammage of the sum of all fine filter layers is preferably 10 to 80 g/m², more preferably 15 to 50 g/m², in particular 20 to 40 g/m².

One embodiment of the structure of the air-permeable material for the respirator mask according to the invention provides a multi-layer structure with a layer sequence described below:

a support layer, one or two fine filter layers and a further support layer.

In particular, if the support layer is constructed as a spunbonded non-woven fabric and the fine filter layer as a meltblown non-woven fabric, a SMS or SMMS structure is used. Instead of a spunbonded non-woven fabric layer, spun-blown non-woven fabric layers may also be used in this construction.

In the respirator masks described, the at least one securing band may comprise a biodegradable plastic material or be formed from one or more biodegradable plastic materials. For example, the biodegradable plastic material may be one of the materials mentioned above.

The securing band may comprise or be formed from a thermoplastic polymer, in particular a biodegradable thermoplastic polymer. The (biodegradable) thermoplastic polymer may be a (biodegradable) thermoplastic elastomer (TPE), in particular a (biodegradable) thermoplastic polyurethane (TPU).

The at least one securing band may have a multi-layer structure, wherein the securing band comprises or consists of a layer of a film and a layer of a non-woven fabric, in particular a meltblown fabric. Thus the securing band may be in the form of a laminate of a TPU film and a TPU meltblown, TPU spunbonded or TPU spun-blown material. This construction results in good elasticity with a high stability of the securing band. Furthermore, such a securing band may be advantageously welded to the filter material piece.

In the case of a securing band in the form of a laminate comprising a film and a non-woven fabric, the film, in particular in the form of a cast film, may be laminated directly onto the non-woven fabric. Thus no additional adhesive is required.

The securing band may be configured as a torsade or twisted cord. This increases the wearing comfort. In this case, it is possible to prevent the twist from twisting back again by thermal fusing (e.g. ultrasonic welding).

The respirator masks described may comprise (exactly) two securing bands.

One or more securing bands may be designed to be guided around the back of the head of a wearer (user). Alternatively, one or more securing bands may be designed to be guided around a wearer's (user's) ear.

The at least one securing band may be designed as a closed strap. This means that the corresponding securing band has no loose or open end. This may be achieved, for example, by coupling both ends of a securing band to the filter part or the filter material piece. Alternatively, for example, the corresponding strap may be configured as a closed strap as such; it may therefore have a ring or loop shape.

According to an alternative, the respirator mask may have at least two, in particular four, securing bands with open or loose ends. This means that (only) one end of each securing band is attached to the filter part or a non-woven web. The open/loose ends of two securing bands each may be knotted.

The at least one securing band may extend over an entire length of the filter material piece or filter part. This allows that the at least one securing band runs with the air-permeable material during production and is cut together with the material (at the ends of the filter material piece).

In particular, two securing bands may be provided which extend over an entire length of the filter material piece or filter part. Preferably, these two securing bands are arranged on the same side of the air-permeable material or filter material piece and along two opposite edges of the filter material piece.

The at least one securing band may be coupled, in particular welded, to the air-permeable material at its two end regions.

The previously described respirator masks may include a bendable nosepiece. This allows to optimize the fit, in particular to enhance the sealing of the respirator mask in the eye and nose area, as well as to improve the retention.

In this case, the respirator mask may consist of the air-permeable material, the at least one securing band and the nosepiece.

The nosepiece may be in a arrangement parallel to the non-welded edge. It may be placed on the outside of the respirator mask or embedded in one of the two non-woven webs.

The nosepiece may comprise a single or a double wire. The single or double wire may be embedded in a strip of plastic material or paper-based material. Alternatively, the nosepiece may also be made of a plastic material without a wire insert. The plastic material may be formed from a biodegradable plastic material. The width of the nosepiece may be 1 to 10 mm.

The length of the nosepiece may be 2 to 25 cm, in particular more than 4 cm and/or less than 10 cm. The nosepiece may also extend along the entire length of one edge of the filter material piece. This allows a simplified production, as the nosepiece may be cut together with the filter material piece during the production.

The nosepiece may be attached to the filter material piece in a destructively detachable or non-destructively detachable manner. Non-destructive detachment allows the nosepiece to be re-used for other respirator masks as well as an easy dismantling of the respirator mask into components that may be disposed of separately.

The nosepiece may be glued or welded to the filter material piece. The fastening by means of adhesive may be done by a hot-melt adhesive. The nosepiece may be coupled to the filter material piece continuously along its entire length or only at individual discrete points.

The part by weight of all biodegradable materials relative to the total weight of the respirator mask may be at least 60%, in particular at least 70%, in particular at least 80%, in particular at least 90%, in particular 100%.

The respirator masks described above may be configured as half masks. In use, they cover thus the wearer's nose, mouth and chin. The respirator masks described above may be configured as medical face masks according to DIN EN 14683:2019+AC:2019 or as filtering half masks according to DIN EN 149.

The air-permeable material of the respirator mask may be creped. The Micrex/microcreper process in particular may be used for this. Merely by way of example, reference is made to WO 2007/079502. The resulting increase in surface area not only causes a softer appearance; the filter material piece also adapts better to the shape of the face and the moisture absorption of this is enhanced.

The invention also provides a respirator mask comprising a filter material piece made of an air-permeable material and at least one securing band,

wherein the air-permeable material comprises at least one layer of a non-woven fabric and/or a layer of a fibre web and the air-permeable material is creped, and

wherein the at least one securing band is designed to secure the respirator mask to the head.

The creped air-permeable material results in an improved respirator mask regardless of the use of biodegradable plastic materials. For this respirator mask, the characteristics, parameters and properties described above are also applicable without the biodegradable plastic materials.

The securing band of the respirator masks described above may be creped. The Micrex/microcreper process in particular may be used also in this case. In the case of the twined or twisted securing band mentioned above, the securing band may be creped before and/or after twining or twisting.

A creped securing band allows an advantageous flexibility enabling an adaptation to different head diameters.

The invention further provides a system (kit of parts) comprising a respirator mask as previously described and a protective cover for the respirator mask. The protective cover may be in the form of a film. The protective cover may, but does not have to be made of a biodegradable plastic material. It may be made of the same plastic material as the air-permeable layer.

The protective cover may be used as a packaging during distribution (e.g. sale or shipping). The protective cover reduces the risk of unwanted premature degradation or decomposition of the respirator mask.

Preferably, the respirator mask is manufactured under low-germ conditions and/or is germicidally treated during or after manufacture. The latter may, for example, consist of a UV treatment.

The invention further provides a protective garment made of an air-permeable material, wherein the air-permeable material comprises or consists of at least one layer of a biodegradable non-woven fabric.

The protective garment may be, for example, a protective bonnet, a protective cover for shoes, a protective cape or a protective overall.

The air-permeable material of the protective garment may also have the characteristics, parameters and properties described above.

Further the present invention relates to the use of a biodegradable plastic material, in particular the biodegradable plastic materials described above, for example in the form of non-woven fabrics for a respirator mask or a protective garment, in particular the manufacturing of a respirator mask or a protective garment. Regarding the biodegradable plastic materials that may be used for this purpose or the possible design of the non-woven fabrics, reference is made in this respect to the preceding explanations.

The present invention will be elucidated in more detail by means of the following exemplary embodiments with reference to the figures, without limiting the invention to the specific embodiments shown. In which:

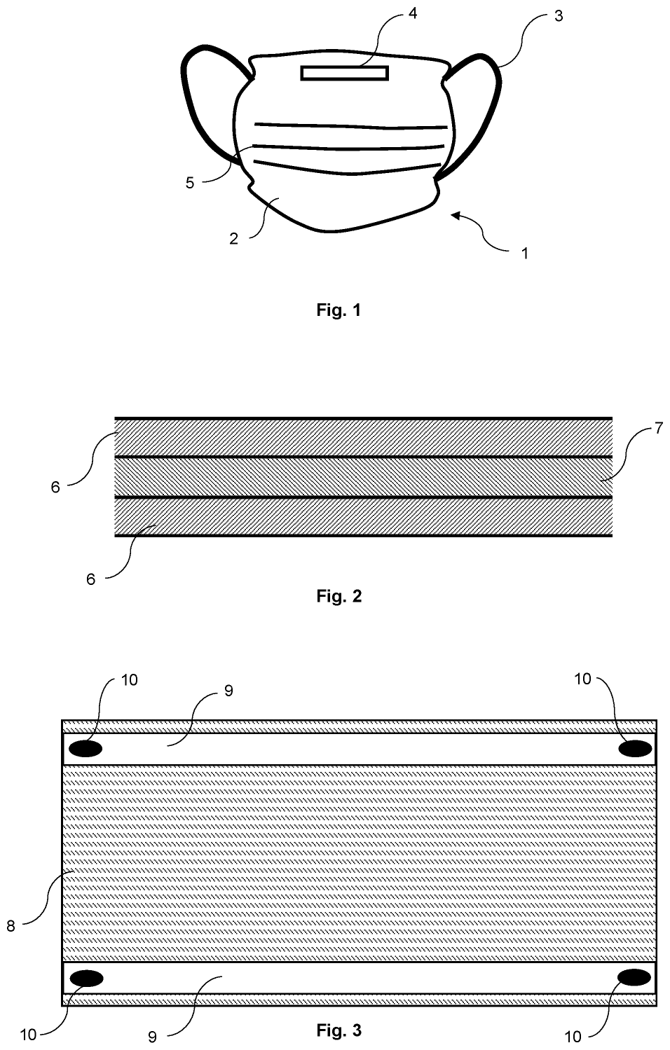

FIG. 1 schematically shows a respirator mask,

FIG. 2 shows a schematic cross-sectional view of the structure of a filter material piece of a respirator mask,

FIG. 3 shows a schematic top view of a respirator mask.

The following procedures are used to determine the parameters described above and below.

Air permeability is determined according to DIN EN ISO 9237:1995-12. In particular, a differential pressure of 200 Pa and a test area of 20 cm² are used. The FX3300 air permeability tester from Textest AG was used to determine the air permeability.

Weight per unit area is determined according to DIN EN 29073-1:1992-08. The method according to standard DIN EN ISO 9073-2:1997-02 is used to determine the thickness of the non-woven fabric layer, wherein method A is used. The method according to DIN ISO 4593:2019-06 “Plastics—Film and sheeting—Determination of thickness by mechanical scanning” is used to determine the thickness of films.

DIN EN 29073-3:1992-08 is used to determine the maximum tensile force. In particular, a strip width of 50 mm is used.

A TSI 8130 tester is used to determine the penetration (NaCl permeability). In particular, 0.3 μm sodium chloride at 86 l/min is used.

FIG. 1 shows a schematic view of a respirator mask 1 in the form of a half mask. The description refers to an example of a medical face mask. The respirator mask 1 shown comprises a filter material piece or filter part 2. The cutting shape of the filter material piece is basically rectangular, but may also take on other shapes, in particular polygonal shapes.

Two securing bands 3 are attached to the filter material piece 2 in the example shown. In the illustrated embodiment, the attachment straps are provided for attachment to the ears of the wearer.

For a better adaptation to the shape of the face, the respirator mask has a nosepiece 4 which is coupled to the filter material piece in a destructively or non-destructively detachable manner. In particular, it may be a wire embedded in a biodegradable plastic material.

A destructive connection consists of welding, for example. The welding may either be disposed continuously along the entire length of the nosepiece or at individual discrete points. Alternatively, the nosepiece may be glued to the filter material piece. For example, a hot melt may be used for this purpose, which typically also results in a destructive connection.

Alternatively, the nosepiece is provided to the user as a separate element. In this case, the nosepiece has a self-adhesive surface that is initially covered with a protective film. After removing the protective film, the user sticks the nosepiece onto the non-woven fabric. Depending on the adhesive material used, such a nosepiece may also be reused for other respiratory protection filter parts.

In the exemplary embodiment, three folds 5 are disposed in the filter part or the air-permeable material 2.

The schematic cross-sectional view of FIG. 2 shows the structure of a filter material piece for a respirator mask. A fine filter layer 7 is arranged between two support layers 6. The three layers may in particular be welded together along the edges, i.e. the circumference, of the filter part 2, as illustrated in FIG. 1.

As an alternative to the structure shown in FIG. 2, the air-permeable material of the respirator mask may also comprise fewer or more layers. For example, only one support layer and one fine filter layer may be provided.

A support layer 6 in the form of a spunbonded or a spun-blown non-woven fabric layer made of PBAT (e.g. Ecoflex from BASF) or another biodegradable polyester such as Duvaltex is in particular suitable. The support layers have a weight per unit area of 5 to 50 g/m² and a titre of 1 to 15 dtex. The HELIX® (Comerio Ercole) process is particularly advantageous as a thermal bonding process for bonding the non-woven fabric.

One or more layers of meltblown non-woven made of PLA with a weight per unit area of 5 to 30 g/m² each are used as fine filter layers 7. At least this layer/these layers is/are electrostatically charged.

Specifically, the filter material piece may consist of a three-layer air-permeable material. A meltblown non-woven fabric layer with a grammage of 20 g/m² is arranged between two spun-bonded or spun-blown non-woven fabric layers with a grammage of 20 g/m². The SMS thus obtained may be ultrasonically welded by a weld seam running along the edges.

The meltblown non-woven fabric may be electrostatically charged by adding additives and a water jet treatment (hydro charging), as described for example in WO 97/07272.

Alternatively, the meltblown non-woven fabric may have a grammage of 25 g/m² and may have been electrostatically charged by means of a corona treatment.

The SMS may be creped. The Micrex/microcreper process in particular may be used for this. Merely by way of example, reference is made to WO 2007/079502. The resulting increase in surface area not only leads to a softer appearance; it also enables a better adaptation to the shape of the face and a better moisture absorption.

FIG. 3 shows a schematic top view of an air-permeable material 8 corresponding to the filter part 2 of FIG. 1. However, in comparison with FIG. 1, FIG. 3 shows the rear of the filter part, i.e. the side facing a user.

In the example shown, a securing band 9 is arranged on opposite edges of the air-permeable material 8 and extends along the entire length of the edge. The securing bands may thus run with the air-permeable material during the production of the filter part and be cut together with the material. In the example shown, the securing band and the air-permeable material are joined by means of a welding point 10 at each of the opposite end regions of each securing band 9.

For the securing band, for example, a TPU laminate consisting of a TPU film with a thickness of 20 to 100 μm and a TPU meltblown non-woven (grammage: 20 to 80 g/m²) is used, which is welded to the filter material piece. The biodegradable TPU may be obtained, for example, according to Z. Wang et al., “Fabrication and Properties of a Bio-Based Biodegradable thermoplastic Polyurethane Elastomer”, Polymers 2019, 11, 1121.

For welding, the process disclosed in the European patent application EP 18213001.3 in a different technical field may be used to achieve high strength.

1. A respirator mask, comprising a filter material piece made of an air-permeable material and at least one securing band,
wherein the air-permeable material comprises at least one layer of a biodegradable non-woven fabric, and
wherein the at least one securing band is configured to secure the respirator mask to a user's head.

2. The respirator mask according to claim 1, wherein the at least one biodegradable non-woven fabric layer comprises a biodegradable plastic material.

3. The respirator mask according to claim 1, wherein the biodegradable non-woven fabric is a dry-laid or wet-laid non-woven fabric or an extrusion non-woven fabric.

4. The respirator mask according to claim 1, wherein the air-permeable material is multi-layered, wherein at least one, more or all of the layers of the multi-layered air-permeable material comprise or are formed from a biodegradable non-woven fabric.

5. The respirator mask according to claim 1, wherein the air-permeable material comprises at least one support layer and at least one fine filter layer, and
wherein at least one, several or all of the support layers or at least one, several or all of the fine filter layers are biodegradable non-woven fabrics.

6. The respirator mask according to claim 1, wherein the biodegradable non-woven fabric layer has a weight per unit area of 20 g/m² to 200 g/m².

7. The respirator mask according to claim 1, wherein the biodegradable non-woven fabric is electrostatically charged.

8. The respirator mask according to claim 1, wherein the air-permeable material comprises at least one support layer and at least one fine filter layer, and wherein the at least one support layer or the at least one fine filter layer is a biodegradable non-woven fabric layer.

9. The respirator mask according to claim 1, wherein the air-permeable material is formed in multiple layers with a layer sequence comprising:
a support layer, one or two fine filter layers, and a further support layer,
and wherein the support layer, the further support layer, or the one or two fine filter layers are each a biodegradable non-woven fabric layer.

10. The respirator mask according to claim 1, wherein the at least one securing band comprises a biodegradable plastic material or is formed from one or more biodegradable plastic materials.

11. The respirator mask according to claim 10, wherein the at least one securing band is of a multi-layer construction, the securing band comprising a layer of a film and a layer of a non-woven fabric.

12. The respirator mask according to claim 1, wherein the securing band comprises or is formed from a thermoplastic polymer.

13. The respirator mask according to claim 1, wherein a part by weight of all biodegradable materials relative to a total weight of the respirator mask is at least 60%.

14. The respirator mask according to claim 1, wherein the respirator mask is configured as a medical face mask according to DIN EN 14683:2019+AC:2019 or as a filtering half mask according to DIN EN 149.

15. (canceled)

16. The respirator mask according to claim 2, wherein the biodegradable plastic material comprises polylactide (PLA), polyhydroxyalkanoate (PHA), polycaprolactone (PCL), cellulose ester, polybutylene adipate terephthalate (PBAT), or polybutylene succinate (PBS).

17. The respirator mask according to claim 2, wherein the biodegradable non-woven fabric is a dry-laid or wet-laid non-woven fabric or an extrusion non-woven fabric.

18. The respirator mask according to claim 1, wherein the air-permeable material is multi-layered.

19. The respirator mask according to claim 1, wherein the air-permeable material comprises at least one support layer and at least one fine filter layer.

20. The respirator mask according to claim 1, wherein the air-permeable material is formed in multiple layers with a layer sequence: a support layer, one or two fine filter layers, and a further support layer.

21. The respirator mask according to claim 1, wherein the at least one securing band is of a multi-layer construction, the securing band comprising a layer of a film and a layer of a non-woven fabric.
